(19) United States
(12) Patent Application Publication
(10) Pub. No.: US 2017/0208821 A1
(43) Pub. Date: Jul. 27, 2017

(54) Bear Repellent Composition and Method of Making the Same

(71) Applicant: Mark Ballou, Southbarre, MA (US)

(72) Inventor: Mark Ballou, Southbarre, MA (US)

(21) Appl. No.: 15/416,905

(22) Filed: Jan. 26, 2017

Related U.S. Application Data
(60) Provisional application No. 62/287,053, filed on Jan. 26, 2016.

(51) Int. Cl. A01N 65/40; B01F 3/20

(52) U.S. Cl. CPC A01N 65/40; B01F 3/2014

(57) ABSTRACT

A bear repellent composition and method of making the same. The bear repellent composition includes onions that have been frozen, subsequently thawed, and allowed to rot for an extended period, such that the onions liquefy. A method of making the bear repellent composition includes inserting a plurality of onions into a first container, maintaining the first container at a temperature of less than zero degrees Celsius for at least seventy-two hours, thawing the frozen onions and transferring them to a second container, shaking the second container until the contents are liquefied, and transferring the contents to third container for four to six months, and subsequently agitating the third container for a half hour once every three or four days. The composition can then be left outside, or may be placed in a spray bottle and sprayed outside to deter bears.

### CROSS REFERENCE TO RELATED APPLICATIONS

This application claims the benefit of U.S. Provisional Application No. 62/287,053 filed on Jan. 26, 2016. The above identified patent application is herein incorporated by reference in its entirety to provide continuity of disclosure.

### FIELD OF THE INVENTION

The present invention relates to animal repellent compositions and methods of making the same. More specifically, the present invention provides a composition for a bear repellent composed of organic ingredients and a method of making the same.

### BACKGROUND OF THE INVENTION

Many individuals spend recreation time outdoors in wooded areas, participating in activities such as a hiking, camping, hunting, and the like. Other individuals live in remote wooded areas. In both cases, the presence of bears is likely. Bears can cause extensive damage to property and can injure or even kill an individual.

Precautions must be taken to ensure an individual's safety in areas where bears are common. It is important to deter the bear from contacting humans or their property, but it is equally important to avoid harming the bear. Some animal repellents exist that are composed of chemicals that cause harm to the bear or its surrounding environment. Therefore, it is desirable to provide a composition for a bear repellent and a method of making the same, wherein the bear repellent is composed of organic material that does not harm the bear or the surrounding environment.

### SUMMARY OF THE INVENTION

In view of the foregoing disadvantages inherent in the known types of animal repellant compositions now present in the prior art, the present invention provides a bear repellent composition and method of making the same, wherein the same can be utilized for providing convenience for the user when repelling bears. One embodiment of the present composition is composed of 100% by weight of onions. A method of making the bear repellent composition includes inserting a plurality of onions into a first container, maintaining the first container at a temperature of less than zero degrees Celsius for at least seventy-two hours, thawing the frozen onions and transferring them to a second container, shaking the second container until the contents are liquefied, and transferring the contents to third container for four to six months, and subsequently agitating the third container for a half hour once every three or four days. The composition can then be left outside, or may be placed in a spray bottle and sprayed outside to deter bears.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flowchart of the method of making the bear repellent composition.

### DETAILED DESCRIPTION OF THE INVENTION

Reference is made herein to the attached drawings. Like reference numerals are used throughout the drawings to depict like or similar elements of the bear repellent composition and method of making the same. For the purposes of presenting a brief and clear description of the present invention, the preferred embodiment will be discussed as used for repelling bears. The figures are intended for representative purposes only and should not be considered to be limiting in any respect.

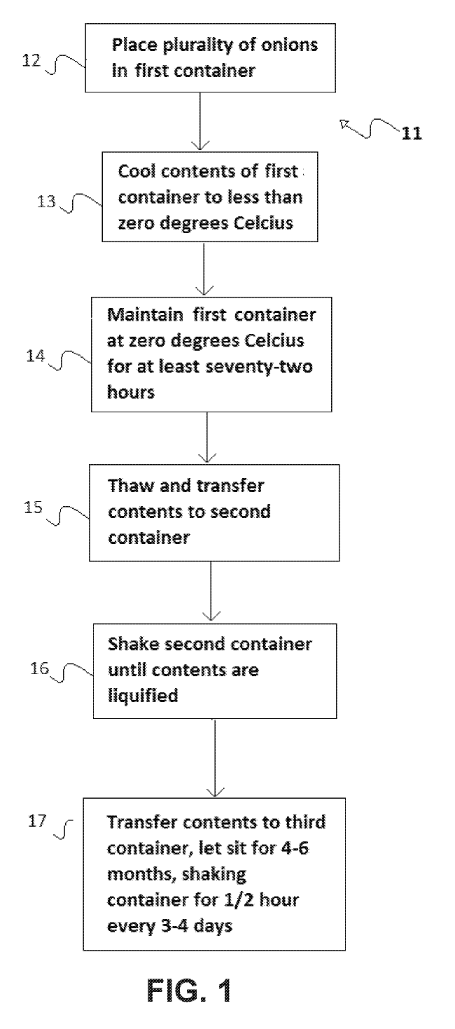

Referring now to FIG. 1, there is shown a flowchart of the method of making the bear repellent composition according to the present invention. In one embodiment, the bear repellent composition is composed of 100% by weight of onions.

A first step for making 11 a bear repellent composition according to the present invention is to place 12 a plurality of onions in a first container. The first container may be any suitable container that is waterproof and leak-proof, such as a plastic freezer bag. The exact amount of onions placed into the container may vary upon how much bear repellent is to be produced. The peel should not be removed from the onion prior to insertion into the first container.

A next step for making 11 the bear repellent composition includes cooling 13 the contents of the first container to less than zero degrees Celsius. Freezing the onions in this manner allows the onions to liquefy once thawed. The first container may be placed in a freezer in order to cool the contents thereof. It is preferable that the first container is maintained 14 at a temperature below freezing for at least seventy-two hours. This allows the onions to freeze completely.

A next step for making 11 the bear repellent includes thawing and transferring 15 the contents of the first container to a second container. The onions should be brought to room temperature, which is typically between twenty and twenty five degrees Celsius. The second container is preferably a large five gallon bucket with an airtight lid.

A next step for making 11 the bear repellent includes shaking 16 the second container until the contents are liquefied. This allows the onions to spoil in a uniform manner. Further, this allows the final product to be an easy to handle liquid form.

A next step for making 11 the bear repellent includes transferring 17 the contents of the second container to a third container, which should also be airtight. The contents may be transferred to any number of smaller third containers. The composition is then left at room temperature for four to six months, allowing the onions time to spoil and rot. The third container should be shaken for a half hour once every three or four days. The additional agitation further aids in the liquefaction process, causing whatever solid particles that remain to dissolve into the mixture, leaving a substantially liquid final product. The final product may be kept within the third container, or may be transferred to another airtight container for storage until the composition is needed.

In order to use the bear repellent composition, an individual may place some of the composition around the perimeter of an area that the individual wishes to keep secure from bears. When a bear attempts to enter the perimeter, the bear will smell the composition and be deterred from entering. Alternatively, the composition may be transferred from the third container to a spray canister. If a bear is dangerously close to an individual, the individual may spray the composition on themselves. Once the bear smells the composition, the bear will become distressed and leave the individual alone. In this way, the bear repellent composition may be used to deter bears from entering a perimeter or for protecting oneself from an imminent bear encounter.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A bear repellent composition, consisting of 100% onions, wherein the onions are in a liquefied state.

2) A method of making a bear repellent composition, comprising:
placing a plurality of onions into a first container;
cooling the first container to a temperature of less than zero degrees Celsius;
maintaining the first container at a temperature of less than zero degrees Celsius for at least seventy-two hours;
transferring the plurality of onions to a second container;
shaking the second container until the plurality of onions are substantially liquefied;
transferring the plurality of onions to at least a third container, wherein the plurality of onions remain in the third container for four to six months;
shaking the third container for a half hour every three to four days.
